(19) United States
(12) Patent Application Publication
(10) Pub. No.: US 2015/0198097 A1
(43) Pub. Date: Jul. 16, 2015

(54) Systems and Methods for Managing a Combustor

(71) Applicant: General Electric Company, Schenectady, NY (US)

(72) Inventors: Siddharth Aphale, Greenville, SC (US); Shiva Srinivasan, Greenville, SC (US); Anthony Wayne Krull, Greenville, SC (US); Sarah Lori Crothers, Greenville, SC (US)

(73) Assignee: General Electric Company, Schenectady, NY (US)

(21) Appl. No.: 14/154,925

(22) Filed: Jan. 14, 2014

(51) Int. Cl. F02C 9/00; G05B 15/02

(52) U.S. Cl. CPC F02C 9/00; G05B 15/02

(57) ABSTRACT

Certain embodiments herein relate to systems and methods for managing a combustor of a gas turbine engine. In one embodiment, a system can include at least one memory configured to store computer-executable instructions and at least one controller configured to access the at least one memory and execute the computer-executable instructions. The instructions may be configured to monitor the dynamic and static pressures of the combustor by a single sensor. The instructions may be further configured to generate a signal based at least in part on the dynamic and static pressures. Furthermore, the instructions may be configured to facilitate in the execution of at least combustor control event based at least in part on the signal.

### FIELD OF THE DISCLOSURE

Embodiments of the disclosure generally relate to a combustor of a gas turbine system and, more particularly, to systems and methods for managing a combustor of a gas turbine system.

### BACKGROUND

Combustion instrumentation is used in a gas turbine engine to manage and monitor conditions of the combustor. Multiple sensors, including sensors for temperature and pressure, are used to determine status and changes of those conditions. Some of the instrumentation may include a dynamic pressure sensor, a static pressure sensor, a flame detector, and an exhaust spread monitor with exhaust thermocouples. These many and different components provide a measure of the conditions of the combustor. However, each of these components is subject to degradation and failure for which each component may require maintenance and/or replacement. Certain components exposed to the extremely harsh conditions of the exhaust duct are especially susceptible to failure which, statistically, significantly contributes to the unavailable operating hours of a turbine. Also, the many components currently needed to monitor the combustor may require a respective amount of space within the system to house all the components. This space could be better used for other purposes. Furthermore, the current need for a relatively high number of components can be relatively expensive because of the initial costs, maintenance, and replacement costs of certain components.

### BRIEF SUMMARY OF THE DISCLOSURE

Some or all of the above needs and/or problems may be addressed by certain embodiments of the disclosure. Certain embodiments may include systems and methods for managing a combustor of a gas turbine system. According to one embodiment of the disclosure, there is disclosed a system. The system may include a pressure sensor operable to monitor static and dynamic pressure of the combustor. These pressures may be indicative of the condition of the combustor. The system may also include a device operable to generate a signal based at least in part on the pressure of the combustor. The signal may be received by a controller and, based at least in part on the signal, the controller may be operable to facilitate at least one combustor event.

According to another embodiment of the disclosure, there is disclosed a method. The method may include monitoring a dynamic pressure and a static pressure of the combustor, both by a single sensor. The dynamic and static pressures may be indicative of the condition of the combustor. The method can also include generating a signal based at least in part on the dynamic and static pressures. Furthermore, the method can include facilitating at least one combustor control event based at least in part on the signal.

According to another embodiment of the disclosure, there is disclosed a system. The system may include at least one memory configured to store computer-executable instructions and at least one controller configured to access the at least one memory and execute the computer-executable instructions. The instructions may be configured to monitor a dynamic pressure and a static pressure, both by a single sensor, where the dynamic and static pressures may be indicative of the condition of the combustor. The instructions may be further operable to generate a signal based at least in part on the dynamic and static pressures. Furthermore, the instructions may be operable to facilitate in the execution of at least one combustor control event based at least in part on the signal.

Other embodiments, systems, methods, aspects, and features of the disclosure will become apparent to those skilled in the art from the following detailed description, the accompanying drawings, and the appended claims.

### BRIEF DESCRIPTION OF THE DRAWINGS

The detailed description is set forth with reference to the accompanying drawings, which are not necessarily drawn to scale. The use of the same reference numbers in different figures indicates similar or identical items.

FIG. 1 illustrates an example system for managing a combustor of a gas turbine, according to an embodiment of the disclosure.

FIG. 2 is a flow diagram of an example method for managing a combustor of a gas turbine.

FIG. 3 illustrates an example functional block diagram representing an example gas turbine combustor management system, according to an embodiment of the disclosure.

### DETAILED DESCRIPTION

Illustrative embodiments of the disclosure will now be described more fully hereinafter with reference to the accompanying drawings, in which some, but not all embodiments of the disclosure are shown. The disclosure may be embodied in many different forms and should not be construed as limited to the embodiments set forth herein; rather, these embodiments are provided so this disclosure will satisfy applicable legal requirements.

Certain embodiments disclosed herein relate to managing a combustor operation. Accordingly, a system can be provided to manage a combustor of a gas turbine engine. For example, the system may include a sensor operable to monitor both static and dynamic pressures wherein the pressures may be indicative of the condition of the combustor. The system may also include a signaling device operable to generate a signal based at least in part on the static and dynamic pressures of the combustor. The system may further include a controller operable to receive the signal and, based at least in part on the signal, facilitate at least one combustor control event. One or more technical effects associated with certain embodiments herein may include, but are not limited to, monitoring and detection of both static and dynamic pressures by a single sensor. By reducing the number of components within the turbine, a corresponding reduction in maintenance and replacement of components may be achieved, in addition to permitting more efficient management of the combustor.

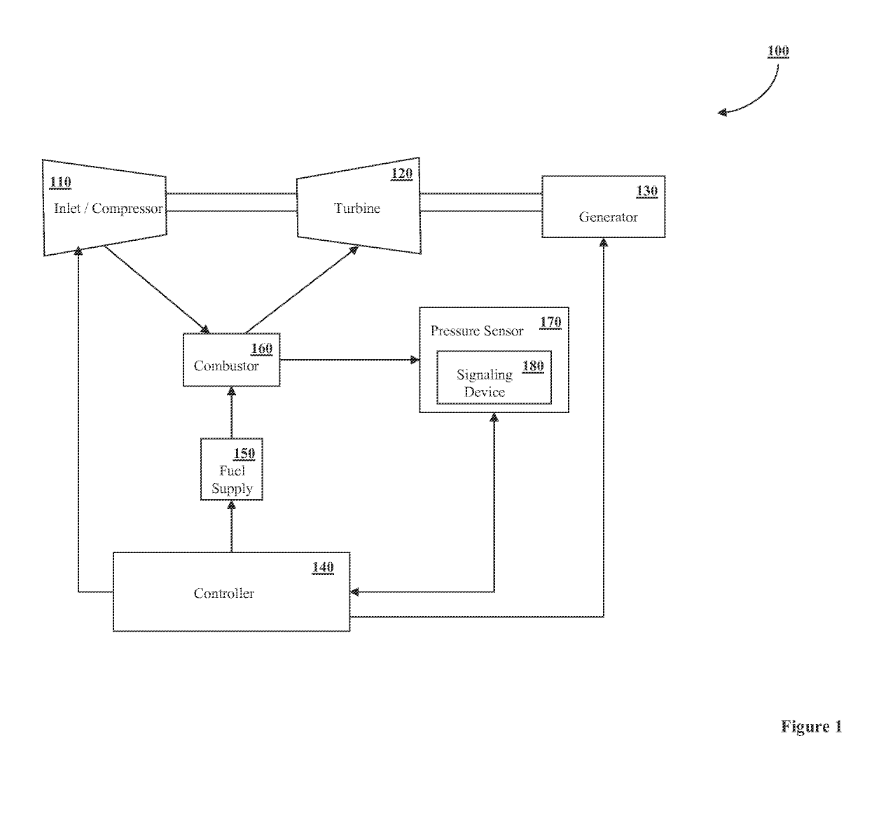

FIG. 1 depicts an example system 100 that facilitates managing a combustor of a turbine. According to an embodiment of the disclosure, the system 100 may include a pressure sensor 170 operable to monitor both static and dynamic pressures of a combustor 160. The static and dynamic pressures of the combustor 160 may be indicative of the condition of the combustor 160. The system 100 may also include a signaling device 180 operable to generate a signal based at least in part on the pressures of the combustor 160. The system 100 may further include a controller 140 operable to receive the signal and, based at least in part on the signal, facilitate at least one combustor control event.

With continued reference to FIG. 1, in one embodiment of the disclosure, the controller 140 may be further operable to compare the signal with a predetermined threshold. In certain instances, the predetermined threshold may include a profile of pressure over a time interval. The profile may include expected pressure and it may include measured pressure of the combustor 160. The profile may provide an indication of the presence or absence of conditions that precede a blowout or loss of flame condition in the combustor 160. For example, individual combustors 160 may exhibit distinctive, repeatable, and observable changes in pressure over a time interval that may be used to predict or anticipate a blowout or loss of flame condition in the combustor 160. In one embodiment, the condition of the combustor 160 may include a flame condition of the combustor 160, for example, whether and to what intensity the flame of the combustor 160 is lit. The condition of the combustor 160 may also include flame holding, lean blowout, can blowout, and can-to-can variation. The condition may be an assessment of can health, further removing the need for components other than the single dual-pressure sensor 170. In a further embodiment, the sensor 170 may be a dual-pressure type sensor and may tap an acoustic damping coil to facilitate in measuring the pressure, including the static pressure.

In one embodiment, the at least one combustor control event may include ignition of the combustor 160. Ignition may be triggered, for example, when a flame-off condition is detected by the sensor 170. The sensor 170 may then cause the signaling device 180 to generate a signal based at least in part on the measurement of static and dynamic pressures, and then transmit the signal to or otherwise allow the signal to be detected by the controller 140. In some embodiments, the sensor 170 may include the signaling device 180. In a further embodiment, the signaling device 180 may be operable to generate a plurality of signals. The plurality of signals may all be received or detectable by the controller 140, and may be indicative of a condition of the combustor 160 at different time intervals, for example, at a plurality of time intervals. In a further embodiment, the controller 140 may be operable to transmit the signal to one or more of an igniter, a compressor 110, a fuel system, or a generator 130. Those destinations may assist in the management of the turbine 120 and/or system 100. For example, the igniter may facilitate ignition of the combustor 160, which may also include communication between the controller 140, the fuel system, and fuel supply 150.

As desired, embodiments of the disclosure may include a system 100 with more or fewer components than are illustrated in FIG. 1. Additionally, certain components of the system 100 may be combined in various embodiments of the disclosure. The system 100 of FIG. 1 is provided by way of example only.

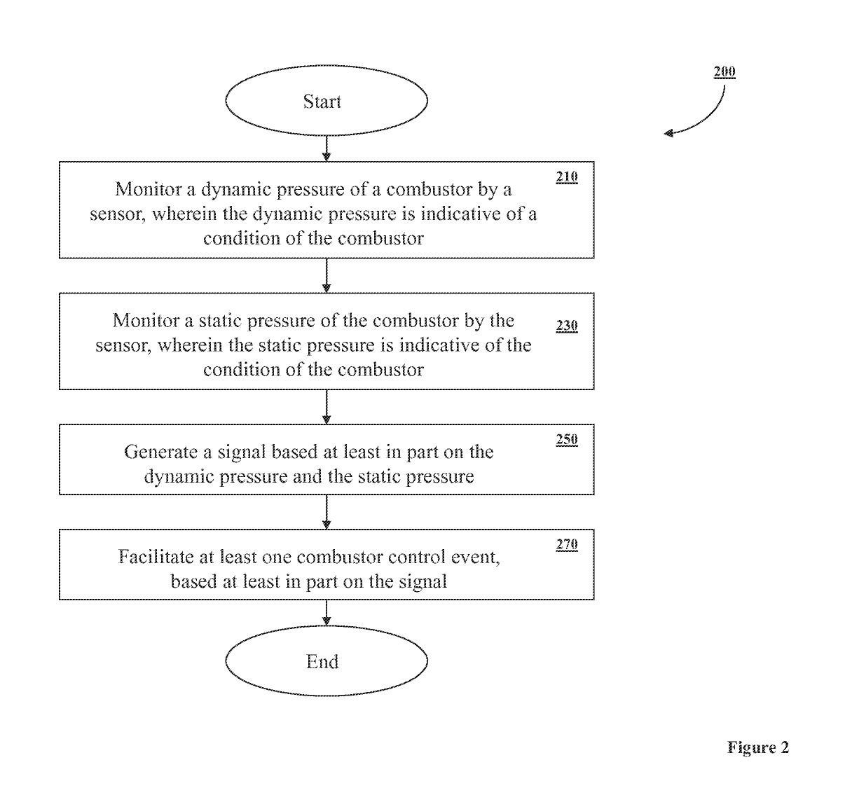

Referring now to FIG. 2, shown is a flow diagram of an example method 200 for managing a combustor of a gas turbine engine, according to an illustrative embodiment of the disclosure. The method 200 may be utilized in association with various systems, such as the system 100 illustrated in FIG. 1.

The method 200 may begin at block 210. At block 210, a sensor, such as sensor 170, may monitor a dynamic pressure of a combustor 160. The dynamic pressure may be indicative of a condition of the combustor 160, and there may be a sensor 170 for each combustor 160, or can.

At block 230, the sensor 170 may also monitor a static pressure of the combustor 160. The static pressure may be indicative of a condition of the combustor 160. The sensor 170 may be a dual-pressure type sensor operable to monitor both dynamic and static pressures at a single time, and the sensor 170 may monitor either pressure individually. In one embodiment, the sensor 170 may be a dual-pressure type sensor and may tap an acoustic damping coil to facilitate in measuring the pressure, including the static pressure. In a further embodiment, the method 200 may include comparing at least one of the dynamic pressure or the static pressure to a predetermined threshold. The predetermined threshold may be stored locally, for example including on memory 350, or it may be stored remotely and accessed by the controller 340 through network 360.

Next, at block 250, the method 200 may include generating a signal based at least in part on the dynamic pressure and the static pressure. The signal may be generated by a signaling device, such as signaling device 180, and the signal may include information other than the static and dynamic pressures. In a further embodiment, the signaling device 180 may be operable to generate a plurality of signals, for example a plurality of signals at different time intervals.

Next, at block 270, the method 200 may include facilitating at least one combustor control event, based at least in part on the signal. The event may be facilitated by a controller, such as controller 140, and the signal may be based at least in part on the static and dynamic pressures. The control event may include facilitating an operation of a device of the system 100. In one embodiment, the control event may comprise ignition of the combustor 160. In one embodiment, the signal may be transmitted to another device of the system 100, or it may be transmitted outside the system 100. For example, the signal may be transmitted to an igniter, a compressor such as inlet/compressor 110, a fuel system, and a generator such as generator 130.

The method 200 of FIG. 2 may optionally end following block 270.

The operations described and shown in the method 200 of FIG. 2 may be carried out or performed in any suitable order as desired in various embodiments of the disclosure, and the method 200 may repeat any number of times. Additionally, in certain embodiments, at least a portion of the operations may be carried out in parallel. For example, block 210 and block 230 may take place at a single time. Furthermore, in certain embodiments, fewer than or more than the operations described in FIG. 2 may be performed.

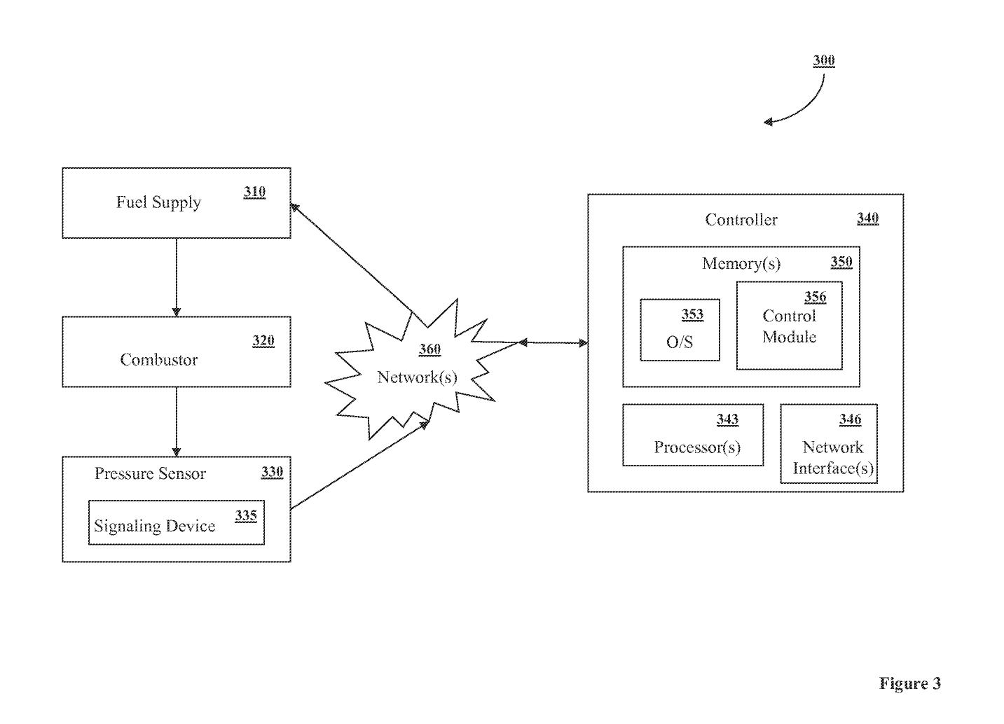

Referring now to FIG. 3, a block diagram is depicted in one example system 300 operable to facilitate management of a combustor. According to an embodiment of the disclosure, the system 300 may include a control module 356 associated with a controller 340. The control module 356 may be configured to monitor a signal associated with a pressure sensor 330 of a combustor management system, like the system 100 of FIG. 1. In some embodiments of the system 300, a pressure sensor 330 may be operable to monitor both a dynamic pressure and a static pressure of a combustor 320. The dynamic and static pressures may be indicative of a condition of the combustor 320. In one embodiment, the sensor may be a dual-pressure type sensor and may tap an acoustic damping coil to facilitate in measuring the pressure, including the static pressure. Based at least in part on the dynamic and static pressures, a signaling device 335 may be operable to generate a signal. Based at least in part on the signal, at least one combustor control event may be facilitated by the system 300. In a further embodiment, the control module 356 may be operable to compare at least one of the dynamic pressure or the static pressure to a predetermined threshold. In one embodiment, the control module 356 may be operable to facilitate transmission of the signal to at least one of an igniter, a compressor, a fuel system, or a generator. For example, the control module 356 may facilitate a change in the fuel supply 310 of the combustor 320. In a further embodiment, the control module 356 may be operable to facilitate an ignition of the combustor 320. In a further embodiment, the control module 356 may be operable to generate a plurality of signals, for example, at different time intervals.

The controller 340 may include any number of suitable computer processing components that may, among other things, facilitate the management of a combustor. Examples of suitable processing devices that may be incorporated into the controller 340 include, but are not limited to, personal computers, tablet computers, wearable computers, personal digital assistants, mobile phones, application-specific circuits, microcontrollers, minicomputers, other computing devices, and the like. As such, the controller 340 may include any number of processors 343 that facilitate the execution of computer-readable instructions. By executing computer-readable instructions, the controller 340 may include or form a special purpose computer or particular machine that facilitates managing a combustor.

In addition to one or more processors 343, the controller 340 may include one or more memory devices 350, and/or one or more communications and/or network interfaces 346. The one or more memories 350 may include any suitable memory devices, for example, caches, read-only memory devices, random access memory devices, magnetic storage devices, etc. The one or more memories 350 may store combustor, fuel, and pressure data, along with executable instructions, and/or various program modules utilized by the controller 340, for example, at least one control module 356 and an operating system (“O/S”) 353. The one or more memories 350 may include any suitable data and applications that facilitate the operation of the controller 340 including, but not limited to, for communication between the controller 340, network 360, fuel supply 310, pressure sensor 330, and signaling device 335. In certain embodiments, the one or more memories 350 may be further operable to store a history of the combustor management. The O/S 353 may include executable instructions and/or program modules that facilitate and/or control the general operation of the controller 340.

Additionally, the O/S 353 may facilitate the execution of other software programs and/or program modules by the processor(s) 343, such as, the control module 356. The control module 356 may be a suitable software module with corresponding hardware capability configured to allow communication with objects outside the controller 340. The control module 356 may include one or more programming modules to facilitate management of a combustor. For example, the control module 356 may communicate with the pressure sensor 330, signaling device 335, and fuel supply 310 via network interface 346 and network 360. The control module 356 may be further operable to facilitate manipulation of the fuel supply 310 based at least in part on a signal from the signaling device 335.

As desired, embodiments of the disclosure may include a system 300 with more or fewer components than are illustrated in FIG. 3. Additionally, certain components of the system 300 may be combined in various embodiments of the disclosure. The system 300 of FIG. 3 is provided by way of example only.

While the disclosure has been described in connection with what is presently considered to be the most practical and various embodiments, it is to be understood that the disclosure is not to be limited to the disclosed embodiments, but on the contrary, is intended to cover various modifications and equivalent arrangements included within the spirit and scope of the appended claims.

This written description uses examples to disclose the disclosure, including the best mode, and also to enable any person skilled in the art to practice the disclosure, including making and using any devices or systems and performing any incorporated methods. The patentable scope of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

These computer-executable program instructions may be loaded onto a general purpose computer, a special purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

The claimed invention can include:

1. A system for managing a combustor, the system comprising:
a pressure sensor operable to monitor static and dynamic pressure of the combustor, wherein the static and dynamic pressures are indicative of a condition of the combustor;
a signaling device operable to generate a signal based at least in part on the static and dynamic pressure of the combustor; and
a controller operable to receive the signal and based at least in part on the signal, facilitate at least one combustor control event.

2. The system of claim 1, wherein the controller is further operable to compare the signal with a predetermined threshold.

3. The system of claim 1, wherein the condition of the combustor comprises at least one of a flame condition of the combustor or a health assessment of the combustor.

4. The system of claim 1, wherein the at least one combustor control event comprises ignition of the combustor.

5. The system of claim 1, wherein the controller is further operable to receive a plurality of signals from a respective plurality of signaling devices.

6. The system of claim 1, wherein the controller is further operable to transmit the signal to at least one of an igniter, a compressor, a fuel system, or a generator.

7. The system of claim 1, wherein the pressure sensor comprises a dual-pressure type sensor.

8. A method of managing a combustor, the method comprising:
monitoring a dynamic pressure of the combustor by a sensor associated with the combustor, wherein the dynamic pressure is indicative of a condition of the combustor;
monitoring a static pressure of the combustor by the sensor, wherein the static pressure is indicative of the condition of the combustor; and
generating a signal based at least in part on the dynamic pressure and the static pressure; and
facilitating at least one combustor control event based at least in part on the signal.

9. The method of claim 8, further comprising comparing at least one of the dynamic pressure or the static pressure to a predetermined threshold.

10. The method of claim 8, further comprising transmitting the signal to at least one of an igniter, a compressor, a fuel system, or a generator.

11. The method of claim 8, wherein monitoring a static pressure comprises monitoring the combustor with a dual-pressure type sensor.

12. The method of claim 8, wherein facilitating at least one combustor control event comprises ignition of the combustor.

13. The method of claim 8, further comprising generating a plurality of signals.

14. A system of managing a combustor, the system comprising:
at least one processor; and
at least one memory storing computer-readable instructions, wherein the at least one processor is operable to access the at least one memory and execute the computer-readable instructions operable to:
monitor a dynamic pressure of the combustor by a sensor associated with the combustor, wherein the dynamic pressure is indicative of a condition of the combustor;
monitor a static pressure of the combustor by the sensor, wherein the static pressure is indicative of the condition of the combustor;
generate a signal based at least in part on the dynamic pressure and the static pressure; and
facilitate at least one combustor control event based at least in part on the signal.

15. The system of claim 14, wherein the computer-readable instructions are further operable to compare at least one of the dynamic pressure or the static pressure to a predetermined threshold.

16. The system of claim 14, wherein the computer-readable instructions are further operable to facilitate a transmission of the signal to at least one of an igniter, a compressor, a fuel system, or a generator.

17. The system of claim 14, wherein the computer-readable instructions are further operable to facilitate a change in a fuel supply of the combustor.

18. The system of claim 14, wherein the at least one combustor control event comprises ignition of the combustor.

19. The system of claim 14, wherein the computer-readable instructions are further operable to generate a plurality of signals.

20. The system of claim 14, wherein the computer-readable instructions are further operable to monitor the combustor using a dual-pressure type sensor.
